(19) United States
(12) Patent Application Publication
(10) Pub. No.: US 2008/0312954 A1
(43) Pub. Date: Dec. 18, 2008

(54) System and Method for Generating and Promulgating Physician Order Entries

(75) Inventors: Meinhard Dieter Ullrich, Santa Cruz, CA (US); Eliot Marvin Rubinov, Santa Cruz, CA (US)

Correspondence Address: CROCKETT & CROCKETT, P.C., 26020 ACERO, SUITE 200, MISSION VIEJO, CA, 92691, US

(73) Assignee: Validus Medical Systems, Inc.

(21) Appl. No.: 11/764,153

(22) Filed: Jun. 15, 2007

(51) Int. Cl. G06Q 50/00; G06F 3/01; G06F 3/12; G06F 3/14

(52) U.S. Cl. 705/2

(57) ABSTRACT

A system and method for generating and promulgating Physician Order Entries. The system uses traditional user interface to obtain physician input, and applies context-free grammars to produce a physician order in a standard format including the expected jargon and syntax of conventional physician orders.

### FIELD OF THE INVENTIONS

The inventions described below relate the field of physician order entry systems.

### BACKGROUND OF THE INVENTIONS

The process of communicating directions or instructions from a physician to other healthcare professionals is critically important in the practice of medicine. Traditionally, physicians generate orders by writing an order in a chart for hospitalized patients or by writing a prescription on a prescription blank for outpatients. The physician typically relies on personal knowledge supplemented by available reference sources (e.g., books, journals, professional consultations, etc.) together with an in-depth understanding of the patient's medical condition when formulating a therapeutic regimen and ordering the appropriate diagnostic testing, medications, or ancillary services. Hospitals currently depend on the education and training to ensure that physicians enter orders in a standard format, and that nurses, technicians and therapist interpret the physician orders uniformly and consistently.

Generally, there are two types of electronic medical record computer systems. The first type is a “stand-alone” system. This is an independent computer system that regulates all of the operational tasks such as medication dispensing, billing, inventory, etc. Typically, two separate hospital departments interface the “stand-alone” system. One department oversees patient admissions, transfers and discharges (ADT) and the other department accepts billing and financial transactions.

The second type of electronic medical record computer systems, the “total hospital system”, is functionally similar to the “stand-alone” system but has been incorporated into a computer network that interconnects all departments of the hospital. Each department (e.g., laboratory, radiology, pharmacy, medical records) is accessible from computers located throughout the hospital.

With “stand-alone” systems physician's orders processing begins with the delivery of written or faxed orders to an appropriate department within the hospital such as the laboratory or pharmacy. Inefficiencies such as illegibility, unnecessary paperwork and task duplication exist in the handling and delivery process. Furthermore, problems with physician's orders are not quickly resolved because of delays involved from when the order was written, received by the appropriate department, and recognized by the related healthcare professional.

“Total hospital systems” attempt to improve the efficiency of the ordering process by transferring the responsibility for entering orders into the computer system to the physicians. For example, these orders may include medications, laboratory tests, diets, etc. In these systems, the physician enters the orders directly from computer workstations. The result is a reduction in paperwork and task duplication. However, a number of problems remain. Computer order entry inefficiencies exist due to slow and cumbersome ordering pathways. Typically, these pathways were not developed by medical professionals and are difficult to follow.

Other order entry inefficiencies in the order entry process are not solved by existing computerized physician's order systems. Relevant patient information is often not readily available to the physician in a complete, comprehensive and organized format. This includes patient medical history, lists of current and past physician's orders, and information on drug allergies and adverse drug reactions. Similarly, present systems often do not keep physicians informed of formulary information and drug availability, and of policies regarding hospital prescribing guidelines and restrictions. For example, prescribing information with respect to clinical practice guidelines, Medicaid restrictions, multi-disciplinary action plans (MAP's), clinical practice standards or clinical pathways all need to be communicated to the prescriber in an effective manner. Further shortcomings in existing systems include the need for providing the prescriber with updated laboratory data and new procedures.

Our pending U.S. Patent Application, Electronic Physician's Order Entering System, U.S. application Ser. No. 11/262,180, filed Jan. 23, 2006, the contents of which is incorporated in its entirety by reference, discloses a graphical user interface for physician order entry. This system provides automatic and simple methods for generating, maintaining and retrieving physician's orders. This system can create physician's orders electronically at the point-of-care and can maintain the orders in an orders' database or print the orders out for use in a paper-based system. Thus, the electronic physician's order system can eliminate or supplement hard copy physician's orders records.

Due to the limitations found in existing medical records and physician's order systems, it is desirable for electronic systems to produce written clinical orders. One method that could be used to produce a written clinical order with standard format orders from a graphical user interface would be to design and use a context free grammar that can produce any clinical order covered by the system. A context free-grammar is a set of rewriting production rules or directives used to generate patterns of strings. Context-free grammars use terminal symbols and non-terminal symbol. A terminal symbol can be thought of as an indivisible entity. It is not possible to express a terminal symbol in terms of other terminal symbols or non-terminal symbols. However, a non-terminal symbol can be defined in terms of terminal and/or non-terminal symbols and will have one or more production rules assigned to the non-terminal symbol. If there are multiple production rules for a non-terminal, one production rule can be picked to rewrite the non-terminal with the sequence of symbols on the right hand side of a production. By applying this strategy recursively starting with a start symbol, a non-terminal, a sequence of terminals may be derived. If these terminals are attributed with strings, concatenating the individual terminal strings will produce a composite string.

Normally, a grammar is used via a parser or compiler to read a string, not to produce it. If a grammar is to be used to help the user construct valid phrases, it may be possible to use either a top-down or a bottom-up approach. For the top-down approach it should be noted, the context-free grammar is represented as an AND/OR-tree. Whenever a non-terminal X is to be substituted by sequence of symbols (terminals and non-terminals) any grammar rule with the left-hand side X can be used irrespective of the context. Therefore the choice of a production represents an OR-node of the AND/OR tree. If a particular rule X:=Y Z is chosen, each of the symbols of the right hand side of this production has to be satisfied. Therefore, each particular production is represented by an AND node. Note that each parse tree adhering to the context-free grammar is a special sub-tree of the AND/OR tree with the property that each OR-node has a fan-out of one, and each AND-node of the sub-tree has the same fan-out as the corresponding node in the AND/OR tree. Since the OR-node has a fan-out of one, it can be combined with its child node, reducing the tree to a pure AND tree. The AND tree is an unambiguous representation of the desired composite string.

A user interface based on a simple bottom-up approach could feature just one selection box. At any given time when building up a sentence, the selection box would offer all text fragments that can be added to a legitimate prefix while staying within the grammar.

These approaches are not user-friendly. The top-down approach forces the user to think like a computer scientist. The top-down approach requires the user to know ahead of time how things are organized in the computer application. The top-down approach may further require the user to backtrack and go down a different production rule if a particular option could not be found in the sub-tree spawned by the production rule the user tried first. The bottom-up approach is time consuming and necessarily forces the user to scroll through long lists of alternatives when building sentences.

### SUMMARY

The systems and methods described below provide for consistent physician order entry in a standard format, and provide means for central control by a hospital to enforce uniform standards of physician order entry. The system is implemented on a combination of mobile terminals such as PDA's and servers. The PDA's are provided with software that presents a GUI interface to the physician. The GUI interface includes various data entry elements, which are presented in context depending on previous entries and selections made by the physician. These data entry elements (dialogue boxes, radio buttons, checkboxes, pull-down selectors, etc.) are filled in by the physician, and the system operates to convert the data entries into a physician order in a standard format desired by the hospital management and familiar to hospital staff. The “standard format”) may be resemble a complete sentence in the native language of the hospital, but more typically it will be a standard short form jargon and syntax typically used in physician orders. This greatly reduces the potential for error in drafting, promulgating, and interpreting physician orders.

The system performs a mapping between a certain class of user interfaces and an attributed context-free grammar. The mapping attaches structure and semantics to any allowed state of the user interface. The mapping creates a standard format string for every allowed state of the user interface. Physicians can create a clinical order as a sentence in standard format by manipulating a set of user interface controls elements in the graphical user interface system. The standard format producing system includes a feedback mechanism by which the user interface is manipulated and altered, in view of the context-free grammar rules, to dynamically configure GUI control elements to present or activate appropriate addition data entry elements given previous entries. If a certain user selection would lead to a user interface state that cannot be mapped to the context free grammar, the user selection will be disabled (e.g., a control element or data entry element may be grayed out, or the content and/or function of radio buttons, checkboxes, pull-down lists etc. can be filtered). This feedback mechanism can be combined with context-sensitive constraints that go beyond what a context-free grammar can provide. The mapping between the user interface and the context free grammar is a sequence of lexeme type-value pairs.

In a simple case, the value entered into a data entry element is just a string. Every individual user interface control element or data entry element contributes a sequence of lexeme type-value pairs that describes the state of the control element. Upon the user changing the state of the user interface, the user interface controller analyzes the control element and determines which control elements are different from their default states and collects their individual lexeme type-value pair sequences. The system concatenates these lexeme type-value pair sequences to one sequence in a deterministic order. The lexeme types correspond to terminal symbols accepted by the context free grammar. The parser parses the lexeme types in the lexeme type-value sequence and constructs a parse tree so that the leaves of the parse tree, read in left-to-right fashion, correspond to the lexeme type sequence. Each leaf is marked with one lexeme type-value pair. Eventually, the values are propagated from the leaves to the root of the parse tree by recursively concatenating the individual value strings from all child nodes by their respective parent nodes. The concatenation may or may not conserve the order of the child nodes. The production rules of the context-free grammar may be attributed with arbitrary processing instructions. The attributed context-free grammar may make a node insert filler strings between the strings contributed by the child nodes, or make the node rearrange the string fragments. More complex instructions that make the string manipulation dependent on context information may also be included. The value constructed at the root of the parse tree constitutes the desired mapping from the user interface.

The standard format producing graphical user interface system can be part of an electronic physician's order entry system such as the one disclosed application disclosed in patent application Ser. No. 11/262,180 filed Jan. 23, 2006. The electronic physician's order entry system lets medical personnel compose clinical orders with a multi-modal user interface. The natural language producing graphical user interface system is able to render any of these orders in natural language sentences similar to standard format physicians and other clinical staff currently use on medical charts. If the GUI has a finite set of content units, each with a finite set of control elements, and a finite number of states (or values) for each control element, then the number of different text strings that can be created by this system may be large but will be finite.

The output of the system is transmitted to physicians, nurses, technicians and therapists through the system, which can store the physician orders for electronic retrieval, in which case they are presented to hospital staff in standard format on-screen. The output may also be distributed in hard copy, by printing the physician order in standard format and distributing it to the patient's medical chart and various departments in the hospital charged with carrying out the various aspects of the physician order.

### BRIEF DESCRIPTION OF THE DRAWINGS

FIG. 1 illustrates physician order entry system.

FIG. 2 illustrates the information model.

FIG. 3 illustrates an example of a linguistic parse tree representing an English sentence.

FIG. 4 illustrates the interaction model used with the system.

FIG. 5 illustrates a flow chart of the system.

FIG. 6 illustrates a typical empty order entry form in the physician order entry system.

FIG. 7 illustrates the natural language producing graphical user interface system when a user interface control elements has been selected.

FIG. 8 illustrates the graphical user interface when a second control element has been selected.

FIG. 9 illustrates the addition of one more item to the order by manipulating a third control element.

FIG. 10 illustrates the order status line after another control element is manipulated.

FIG. 11 illustrates the control unit of FIG. 10 with a fully completed physician order displayed in a status line.

FIG. 12 illustrates the effect of de-selection of certain control elements.

FIGS. 13, 14 and 15 illustrate the operation of the grammar in building a standard format physician order from a series of physician entries in the user interface.

### DETAILED DESCRIPTION OF THE INVENTION

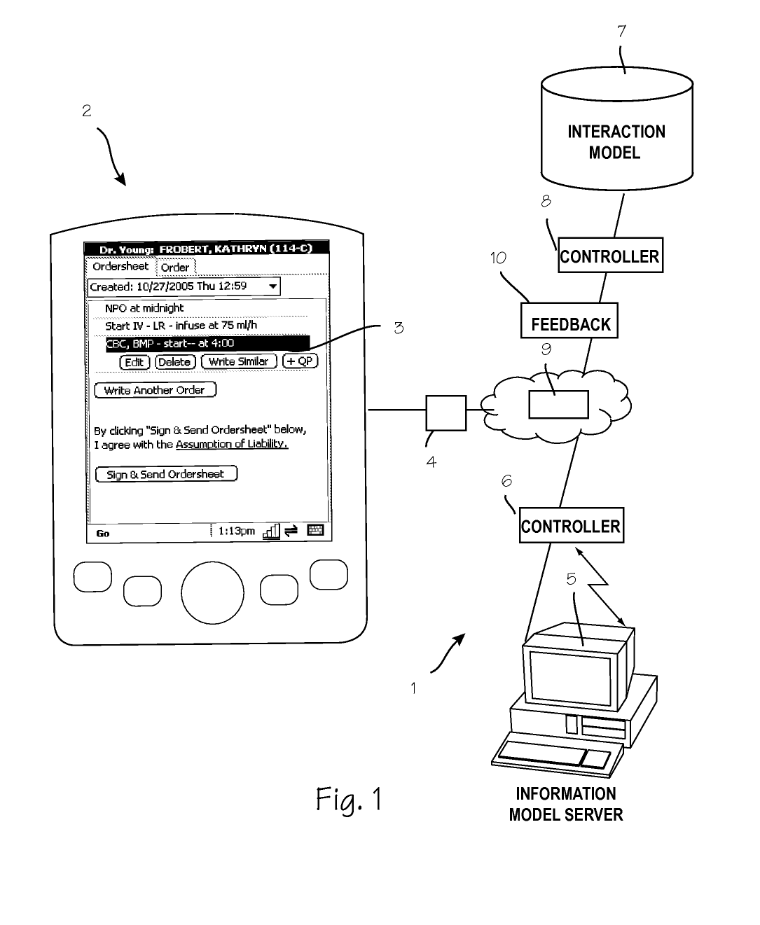

FIG. 1 illustrates physician order entry system 1 where manipulation of a graphical user interface system (GUI) generates a physician order in standard format output. The system comprises a plurality of mobile client terminals (PDA's or other client computers) with a graphical user interface 2 having control and data entry elements 3, a graphical user interface controller 4 used to control the manipulation of control elements, an information model 5, an information model controller 6 used to implement the information model, an interaction model 7, an interaction model controller 8 used to implement the interaction model and a parser or compiler 9. The information model uses input symbols or tokens in conjunction with a context-free grammar and a feedback mechanism 10 to generate natural language grammar strings. By using the feedback mechanism 10, the interaction model controls and performs input validations as well as compatibility tests and determines which user interface control element may be activated or deactivated. Controllers 4, 6 and 8 may be any type of processor or programmable device able to execute instructions.

The interaction model governs, through the interaction model controller, the organization of the GUI, gathers information from the GUI and determines how manipulation of the graphical user interface generates standard format sentences (i.e., physician orders). The interaction model uses a combination of the static GUI content (content units and control elements) and a snapshot function of the GUI at a particular point in time to generate standard format strings. When generating standard format sentences from UI manipulations, the interaction model employs the information model.

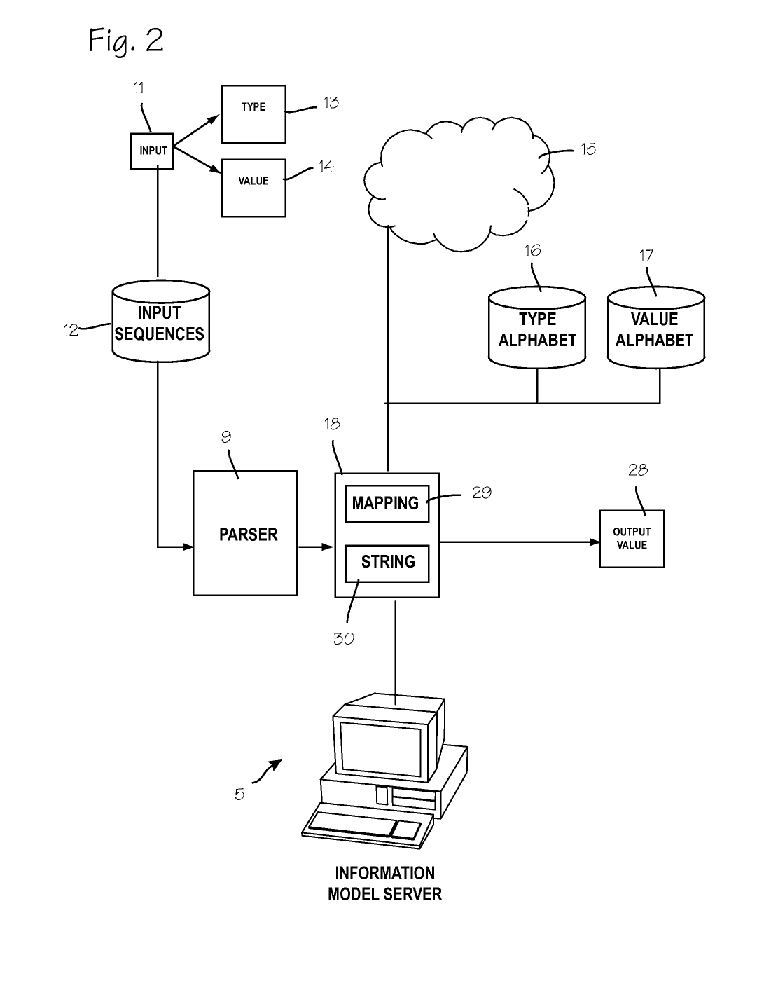

FIG. 2 illustrates the information model and its implementation in more detail. The information model utilizes one or more input symbols or tokens 11 originating through manipulation of the control element and input sequences 12 created from the set of input symbols placed into the system by a user. The input symbols 11 are tuples having a lexeme type 13 and a value 14. For example, in the English language, a lexeme type can be thought of as a category type for words such as noun, verb, adverb, adjective, etc. In the physician ordering system, the lexeme type can be thought of as a broad category type for expected indications and diagnoses, devices, services, therapeutic procedures, diagnostic procedures, and prescriptions. The information model comprises a context-free grammar 15 having production rules, an alphabet of lexeme types 16 that correspond to terminal symbols accepted by the context free grammar, an alphabet of values 17 that may be carried by the input symbol 11 and a recursively defined value function 18 that assigns a value to any node of a parse tree.

In this system, the context-free grammar 15 may be represented by the symbol G. A context-free grammar is a set of re-writing production rules or directives used to generate patterns of strings. In our system, we use the context-free grammar to produce, among other things, a standard format language string for use in physician orders. The set of all parse trees P which can be spawned bathe context-free grammar G is reflected by the symbol Π in the equation Π=∪ P. A parse tree or concrete syntax tree is a tree that represents the syntactic structure of a string according to the context-free grammar G. A program that produces such trees for a given grammar and a given input sequence is called a parser. Parse trees may be generated for sentences in standard formats such as physician order jargon and natural languages such as standard English.

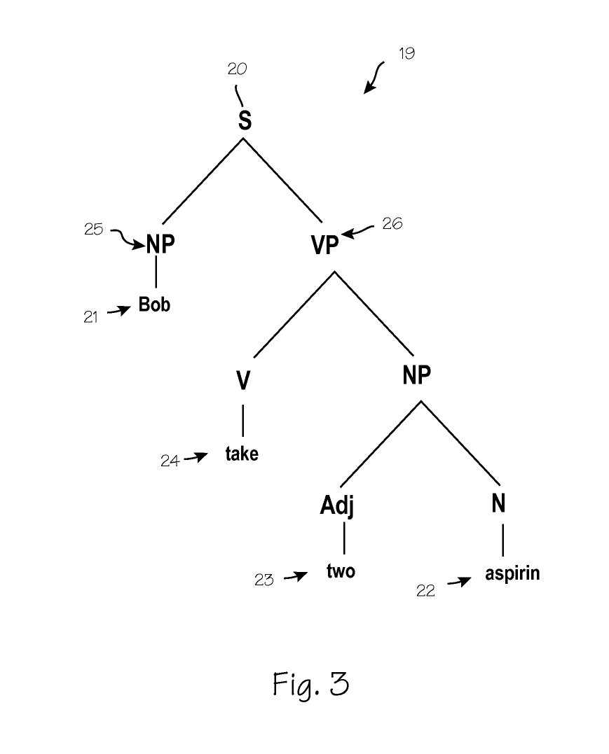

A parse tree is made up of nodes and branches. An example of a linguistic parse tree representing an English sentence is illustrated in FIG. 3. The sentence is “Bob, take two aspirin.” In FIG. 3, the parse tree 19 is the entire structure, starting from the root node 20 (S) and ending in each of the leaf nodes 21, 22, 23 and 24 (Bob, aspirin, two, take). Branch nodes 25 and 26 (NP and VP, respectively) represent non-terminal symbols.

Referring back to FIG. 2, the set of all parse trees Π is the union of all possible parse trees produced by our context-free grammar G. The input symbol or token 11 is represented by s=(t,v) and comprises lexeme type t (indicated by item number 13 in the Figures) and value v (indicated by item number 14 in the Figures). The alphabet τ of lexeme types 16 is represented by τ=t₁, t₂ . . . tₙ. The alphabet of values 17 that the input symbol 11 can carry is represented by ν=v₁, v₂, . . . vₗ. The set of all sequences 12 of lexeme types t that are created by a user and accepted by the context-free grammar G with item number 15 is represented by T and described by the equation T⊂ τ*, where the set of all sequences T is a subset of the set of all strings over the alphabet τ of lexeme types. The Kleene operator ‘*’ marks the closure over the alphabet τ of all strings t₁, t₂ . . . tₙ with tᵢ ε τ and n<=∞. The context-free grammar G induces a parsing step or mapping represented by g:(τ×ν)*→Π∪{Ø} through the parser 9. In our system 1, the input sequence is extracted from the GUI.

Lexeme types 13 are parsed to construct parse tree P, but the leaves Λ_{P}=λ_{P,1}, λ_{P,2}, . . . , λ_{P,1} of parse tree P will be marked with the complete tuples (t,v) to preserve the input values. The function 18 that assigns an output value o ε O, which is the domain of producible values, having item number 28 in the Figures to a parse tree P is represented by the notation φ:Π∪{Ø}→ ∪ nil. In a simple example, output value o ε O, which is the domain of producible values, (having item number 28 in the Figures) represents a string, or more formally, a sequence of characters ω from an alphabet Ω. (O=Ω*;Ω={ω₁, ω₂, ωₘ}). The value function φ (indicated by item number 18 in the Figures) is able to extract information from the parse tree. Value function φ is the recursively defined function that assigns a value to any node of a parse tree for G and hence to the root of a parse tree as well. In this context, the output value of a node also represents the output value of the sub-tree rooted by that node.

The set of all non-terminals ρ defined by context free grammar G is represented by ρ=r₁, r₂, . . . . The set of the inner nodes of the parse tree P is Kₚ=K_{P,1}, K_{P,2}, . . . , K_{P,m}. Each inner node K_{P,l} is marked with a non-terminal symbol and an attribute α which is assigned a compound value. That value will be derived from the child nodes of K_{P,i}. A node of P is represented by νε(K_{P}∪Λ_{P}). The children of an inner node K (in left-to right order) are ν₍₁₎, ν₍₂₎, . . . , ν₍ₖ₎. Value function φ (indicated by item number 18 in the Figures) assigns a value to ν as follows:

$$φ ( υ ) = \{ \begin{matrix}{f}_{t} ( υ ) \\ {f}_{r} ( φ ( {υ}_{( 1 )} ) , φ ( {υ}_{( 2 )} ) … φ ( {υ}_{( k )} )\end{matrix} \} if \begin{matrix}υ ∈ {Λ}_{P} \\ v ∈ {K}_{P}\end{matrix}$$

The value function 18 uses a mapping function fₜ indicated in FIG. 2 by item number 29 and a string function 30 represented by fᵣ(ν). Every mapping function fₜ indicated by item number 29 performs a mapping of the input symbol 11 having tuple (t,v) to a string or nil. In concrete applications the values allowed for a lexeme type t may be a subset νt⊂ν. As part of the feedback mechanism, if the function doesn't accept an input value v having item number 14, the system may enter an error state. Also, mapping function fₜ indicated by item number 29 in FIG. 2 may be dependent on t and disregard V. Each string function 30 represented by fᵣ(ν) depends on the non-terminal r₍ⱼ₎ and the attribute value α₍ⱼ₎ that are associated with the inner node ν and builds a standard format string from the set of strings yielded by the children of ν. In the simplest case, string function fᵣ indicated as item number 30 just concatenates or combines the children's strings, possibly inserting constant filler strings before, between and after the constituents. If there is no parse tree for an input sequence 12, g, will deliver the value Ø. We also allow the functions fₜ indicated as item number 29 and string function fᵣ indicated as item number 30 to yield nil. This comprises part of the feedback mechanism and allows for input validation and compatibility tests, which are generally context-sensitive and cannot be formulated through typical grammar design. (Example: A particular lexeme type t having item number 13 may at most occur three times in the input, and all occurrences must carry different values.) The function fᵣ indicated by item number 30 yields nil if one of its input values is nil. For completeness, we set φ(Ø)= nil. The value function φ is able to combine and manipulate values that are collected from the input sequence and propagate them to the root node of a parse tree.

By using vector functions, which are functions with multiple input and output variables, value function φ (indicated by item number 18 in the Figures) may, in parallel, also propogate other information about the parse tree like meta data assigned to individual nodes (corresponding to production rules for non-terminals) and even the structure of the parse tree itself. One application of this idea is (the recursive) setting of key/value pairs to capture semantic information. This may include such things as displaying a stat electronic physician order in the color red or automatically routing an electronic physician order to an appropriate department or computer system

Finally, the system maps the input sequence S=((t₁, v₁),(t₂, v₂), . . . ) to a standard format string or more generally to a value by simply applying the function composition γ=(φ· g). This yields the new function γ:(τ×ν)*→O ∪nil. The values v₁, v₂, . . . do not influence which parse tree gets constructed when applying the parsing step g. The values will be passed through and consumed by the value function φ. However, modern parsers that are built with general-purpose parser generators such as Yacc, which is a parser generator for use on Unix systems, are able to integrate both the parsing step g and value function φ with each other. We can refer to (τ, ν, g,φ) as the information model 5 or Mᵢ.

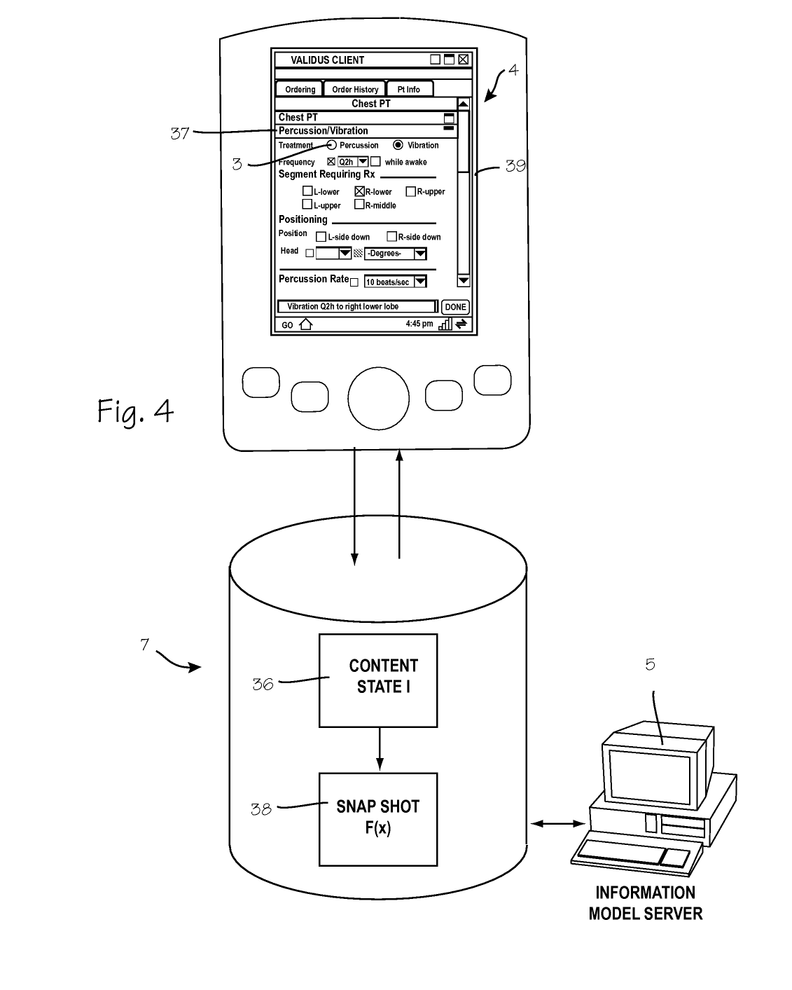

FIG. 4 is an illustration of the interaction model in our system 1. The interaction model 7 organizes the graphical user interface 2, gathers information including input symbols from the graphical user interface 2 and determines how the manipulation of the graphical user interface will generate a natural language sentence output. The interaction model is implemented in the system using the interaction model controller. The interaction model 7 uses the static content 36 of the graphical user interface including the content of content units 37 and control elements 3 and a snapshot function 38. The GUI 2 can be divided into content units u (indicated by item number 37 in the Figures) such as pages, screens, sections or forms that display sets of control elements c (indicated by item number 3 in the Figures). Control and data entry elements may include form fields, check boxes, radio buttons, entry boxes and selection boxes given item number 3. A navigation mechanism (in this case the pointer 39) by which the user can navigate from one content unit to another is provided, and may include pointer icons, scroll bars, page icons and other graphical elements that may be manipulated with an input device. Input mechanisms may include a stylus (in combination with a touch screen), a fingertip, or a mouse, joy-stick or any other suitable input means.

The state I of the set of content units 37 at a particular time, which is also referred to as static content 36, contains all the information that is captured by the GUI at that time. The UI selections can be user selections such as radio boxes, pull-downs, etc. and can include default values or presets. Static content is the set of all values that are pre-loaded into the system and bound to the various control elements and data entry elements through which the user can access or select various interface features. The sequence in which the user traverses the GUI 2 and manipulates control elements can also belong to state I. The steps the user takes to navigate to the content unit may also be utilized by the interaction model and belong to state I. A content unit 37 may serve as a template and may have different meanings if different navigation paths can land the user on that unit.

A binding function θ:c→((t_{c,1}, v_{c,1}), (t_{c,2}v_{c,2}), . . . , (t_{c,m}v_{c,m})) is assigned to every activated control element or data entry element c(indicated by item number 3) by the interaction model controller 8. The t_{c,i} are control-specific constants and each v_{c,i} is a function value reflecting the state of the control element c indicated by item number 3 (the user selection) and may also reflect the content unit 37 which contains the control element 3. Value v may also yield a constant or special value. Use of a special value is appropriate if the mapping function fₜ in the information model 5 disregards v. This may be the case for check boxes in which the existence of t alone may provide the required information. If a control element or data entry element 3 is deactivated (i.e. a radio button assumes the status ‘none’, a check box is un-checked, an edit box is empty or ‘none’ value in a selection box is selected), the control element or data entry element emits the empty sequence ε.

A snap shot of the GUI can be taken at any time while the user interacts with the GUI 2. It is possible to take a snapshot Θ using the snap shot function 38 of the complete state 36 or image l of the GUI. The complete state or 36 or image l of the GUI is represented by the equation I=s₁(c₁), s₂(c₂), . . . s₁(cₗ). The snapshot function 38 of the GUI image reflected by Θ(s₁(c₁), s₂(c₂), . . . sₗ(cₗ))or short Θ(c₁, c₂. . . cₗ) is the concatenation or connection of the ordered sequence of all control bindings θ(c₁)+θ(c₂)+ . . . +θ(cₗ).

### If

θ(c₁)=((t_{c1,1}v_{c1,1}), (t_{c1,2}v_{c1,2}), . . . ,(t_{c1,m}v_{c,m})) and

θ(c₂)=((t_{c2,1}v_{2,1}), (t_{c2,2}v_{c2,2}), . . . ,(t_{c2,n}v_{c2,n})) and

θ(c₃)=ε,

then

Θ(c₁, c₂)=θ(c₁)+θ(c₂)=((t_{c1,1}v_{c1,1}), (t_{c1,2}v_{c1,2}), . . . , (t_{c1,m}v_{c,m}) (t_{c2,1}v_{c2,1} ), (t_{c2,2}v_{c2,2}), . . . , (t_{c2,n}v_{c2,n}))

and

Θ(c₁, c₃)=θ(c₁)+θ(c₃)=θ(c₁)

Where the sequence in which the user traverses the GUI and manipulates control elements belongs to l or the static content 36, the cᵢ are fed into snapshot function Θ having item number 38 in the order the user has manipulated the respective control elements. Where the steps the user took to navigate to a content unit are utilized to produce the standard format output, each possible navigation link may also be assigned a mapping. Navigating from one content unit 37 to another may involve a chain of navigational steps or links. For example, in a prescription content unit, the available content elements may be varied depending on previously accessed diagnostic content units.

In a further embodiment of the invention, the binding is expanded so that in addition to yielding pairs (t,v), a control element 3 (and any navigation link), may also set a variable. The scope of the variable may be global or local to a content unit. (A new scope for a family of variables may also be initiated if a value v of an active control element 3 can be interpreted as a demarcation symbol.) Each value v_{c,i} may not only depend on the state of its associated control element 3 but also on the state of one or more variables. Certain variables may be automatically set for a content unit 37. If a content unit is a template, unique instances of the content unit with state specific context may be invoked depending on how the user got to the content unit. That context may be reflected by the values of context variables local to the content unit 37.

In the remainder of this application, interaction model 7 may be represented by the notation Mᵤ, which refers to the combination of the static GUI content (content units and control elements) and the snapshot function Θ having item number 38. The term may also be used for a concrete implementation of this model.

Information from the interaction model is mapped onto the information model with the assistance of a feedback mechanism. The system uses a function μ=γ·Θ=φ·g·Θ for mapping an arbitrary state of the GUI to an output. However, the state l of any given GUI cannot generally be reconstructed from the information model output o that resulted from I. If the information model Mᵢ is reasonably discriminative (i.e. it doesn't just accept any input), many states in interaction model Mᵤ will map to special states, and will be treated as error states. To avoid or limit instances of error states achieved by the system, the system employs the following feedback strategy: After each user interaction, the system operates feedback mechanism to perform a what-if analysis for all visible control elements (usually all control elements on the currently visible content unit). The system computes all possible states I′ that can be reached from the current state I by manipulating one control element. If μ(I′) is not nil or a special state, then the respective control element remains accessible, otherwise it will be disabled (e.g. grayed out). Note that for some control elements like selection boxes, this may mean that individual components of the control element are either enabled or disabled. This ensures that the user always stays within the bounds of the information model. Note, that there are partial input sequences S for which φ(S)=nil. However, if there is at least one input continuation ΔS, so that φ(S+ΔS)≠nil, then we want to allow states I in the interaction model for which Θ(I)=S.

The information model is generally able to decide whether there is a continuation for a partial input. If used in feedback mode, the information model may return a special value to signal that manipulating a control leads to an incomplete but valid state. The interaction model may in turn employ means to tell the user that a current state I is valid but incomplete. For example, if the user wants to finish a task with an incomplete input, the system 1 may display an alert and wait for additional input. The feedback mechanism may guide the user through the GUI by making certain control elements inaccessible to the user. The feedback mechanism also reduces the size of the available alphabet of lexeme types 16 and the alphabet of values 17 by making these alphabets inaccessible to the information model.

The implementation of the interaction and information models may be located on the same computer system or physically and spatially distributed. In one of our implementations, the Interaction Model runs on a wirelessly connected Portable Digital Assistant (PDA) having a programmable processor operably connected to a transmitter and a receiver. The Information Model runs on a server having a programmable processor operably connected to a transmitter and a receiver. The interaction model may also run on other portable electronic devices having a processor such as mobile phones or laptop computers. Both the information model and interaction model computer may be part of program article tangibly embodied in a computer-readable medium or a propagated signal where the computer program article comprises instructions operable to cause a programmable processor to perform functions according to the program. The PDA and server may both further comprise a memory operably coupled to the processor. The memory in the server and wireless device may contain program code for the information model and/or the interface Model.

The information model and interface model may communicate through a custom protocol (e.g. running on top of a TCP/IP or UDP/IP connection). The PDA is preferably programmed as a very thin client. The client may download the complete Interaction Model at once (and occasionally obtain model updates), or the client may download required content units on demand, which it may cache or discard if they are no longer used. The extensive computing needed to map the user interactions to a semantic representation may be performed by the server. After each user interaction, the client sends the state of the GUI to the server. The server calculates and returns a parse string (a standard format sentence or sentence fragment), which the client PDA displays in a status line. The client also sends a vector of identifiers to the server. Each identifier denotes a control element. The server runs a what-if analysis for each of these control elements and sends back a Boolean vector that states for each control element whether it should be accessible.

The system may be augmented by speech recognition. The system may be operably coupled with off-the-shelf speech recognition products, which are generally used for telephony-based dialog systems. Speech recognition can be used for at least three different tasks: Command & control, navigation and content selection. These tasks may be associated with three modes of the application, whereby either the application may select a mode based on the context (e.g. the last user interaction) or the user may actively switch between modes. A user may click a command & control icon and then utter the sentence “show patient's health record.” This may be a short-cut to switch away from the main application and access data that may otherwise be significantly harder to access. The user may be in navigation mode and utter the sentence “go to soft diet form” to directly navigate to a particular form. Lastly, the user may look at an empty form and manipulate a number of control elements at once by speaking “Nothing by mouth after midnight except cardiac medications.”

Another application for the system is the offering of a flattened view of an intrinsically hierarchical data input problem. To use an extreme example to illustrate this point, assume that data input is aligned with a decision tree. If within one form A the user selects a first set of values for a set of variables by means of control elements, the system presents a first follow-up form B1 with control elements for setting variable values; and if the user selects a second set of values on form A, the system presents a second form B2 with another set of control elements for associated variables. At a minimum, form B1 contains at least one variable that is not accessible from form B2 (or form B2 contains at least one variable that is not accessible from form B1). After filling in form B1, the system may again select a new form depending on the choices the user made on form B1. This system can be replaced by a very big form that combines all control elements from all forms. (Control elements that manipulate the same variables are purged.)

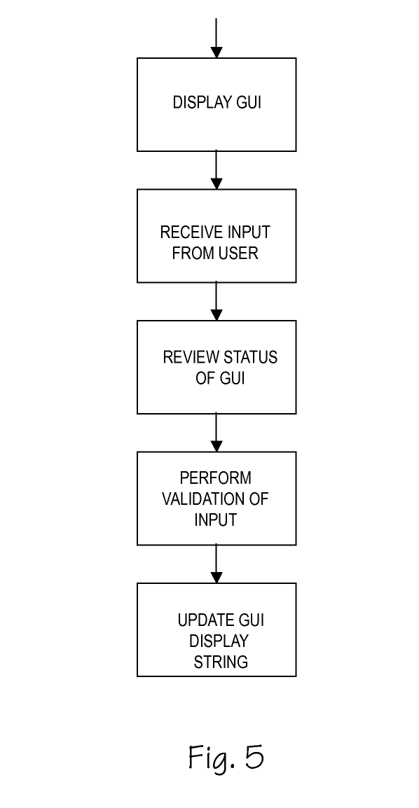

A flow chart of the natural language producing graphical user interface system in use is shown in FIG. 5. The graphical user interface of physician's order form with control elements is displayed to a user. The user may manipulate the control elements changing the state of a user interface to fill in the order form. The system reviews the status of the user interface control elements and determines which control elements are different from their default states. Input symbols with lexeme type-value pair sequences corresponding to the current state of the control elements are collected. The input symbols may be subjected to input validation and compatibility tests by the feedback mechanism. The feedback mechanism determines if a remaining user selection and corresponding input symbol would lead to a state of the user interface that cannot be mapped to the context free grammar. In such a case, the system disables control elements that would lead to a state that cannot be mapped. Once the lexeme type-value pair sequences are collected, the lexeme type-value pair sequences are then concatenated or combined to create Θ(I)=S, the sequence of tuples. The standard format string (which may be a sentence or sentence fragment) is the result of applying the function γ=φ·g to the sequence S. The graphical user display is updated and the standard format string is displayed to the user on the graphical user display.

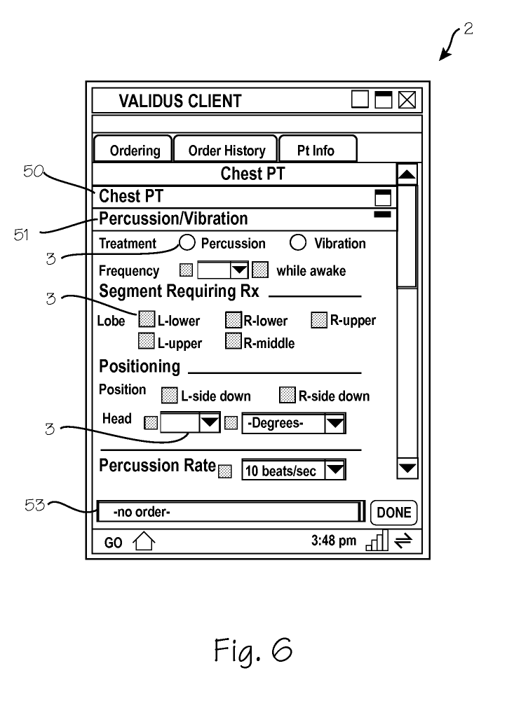

FIGS. 6 through 12 illustrate the operation of the system in more detail. FIG. 6 shows a screen shot of the graphical user interface of the system having a typical empty order entry form in an electronic physician order entry system. Each such order entry form may have its own unique context-free grammar and production rules. The order form is a graphical user interface and may contain one or more content units 37 that can be opened or closed, each of which contain various content elements 3. In FIG. 6, the content unit “Chest PT” (item 50) is closed and is hidden behind the opened content unit for “Percussion/Vibration” (item 51). A form section can contain any number of user interface (UI) control elements like radio buttons, check boxes, scroll-down menus (several are labeled as item 3) (which are often combined with check boxes that gate the pull-down and allow the pull-down control to be unselected), cascading pull-downs, text entry fields (for “free text” input) and popup menus (which are typically used to present a ‘choose many’ selection).

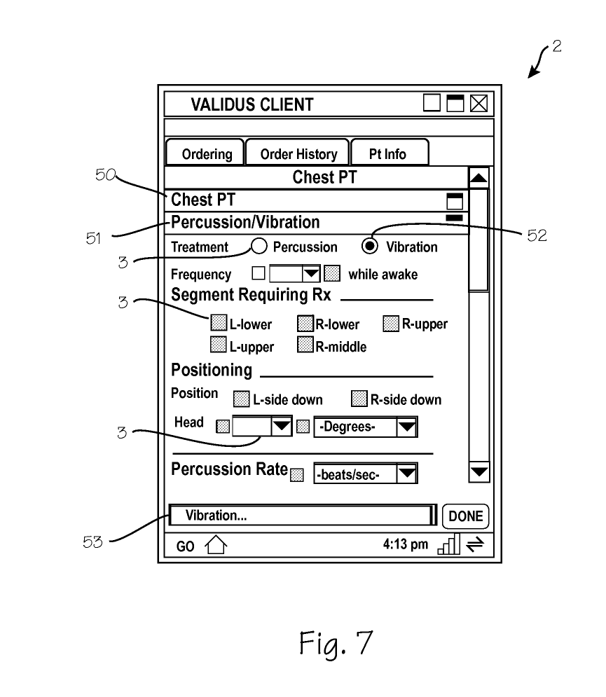

FIG. 7 illustrates the graphical user interface of the system in which the user has selected the control element item associated with an order for vibration (item 52). An order contribution sequence is comprised of tuples (terminal_lexeme type, text_value). The first tuple is filled in by the physician if the section is active, i.e. if at least one of the section's control elements has been manipulated. The second tuple is emitted through wireless communication from the server to the PDA. This order contribution sequence can be partially parsed by the grammar associated with this form and a partial order sentence is produced. This selection will make the UI 2 transmit the following order contribution sequence comprising two tuples:

[(SVC_Types.Resp_Therapy, ″″),

(SVC_Therapies.Vibration, “Vibration”)]

The first tuple indicates the Respirator Therapy lexeme type was selected having a string value of ″″. The second tuple indicates Vibration Therapy was selected having a string value of “Vibration”. In FIG. 7, the radio box 52 has been manipulated by the user, and the server has interpreted this and generated and transmitted the string “Vibration . . . ” for display status line 53 of the content window on the user device. The system indicates to a user when more input is required and ensures that the user always stays within the bounds of the information model. Here, the ellipsis marks in the order status line show that the order displays in the status line is not yet complete, and that the physician must manipulate other control(s) on the order form to finish the order. The system can also guide users to the next control element or control unit required to complete an order using various feedback mechanisms in the user interface. This is illustrated in FIG. 7, in which the system has altered the display of the frequency pull-down menu to shows that the pull-down menu is enabled, while displaying a grayed or dimmed control elements for other functions that are still disabled.

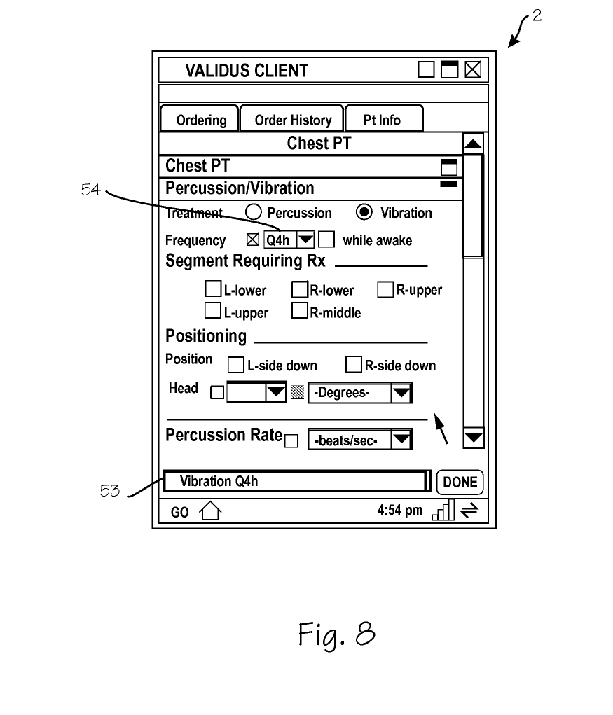

FIG. 8 illustrates the graphical user interface 2 after a second control element 54 has been selected by the user. IN this figure, the physician has selected the value “Q4h” from the frequency pull-down menu (control element 54). Upon selection of this control element 54, the system operates to change the checkbox control element associated with the pulldown menu. (Unchecking the box would treat the pull-down as if nothing was selected.) The standard format string “. . . Q4h to . . . ” is added to the green order status line and now the order status line 53 shows “Vibration Q4h”. No ellipses marks are shown: the system displays the string without ellipses to indicate that it represents a complete order. This indicates to the user that all further control elements are an option. If another control is manipulated, control elements could grey out or be rendered un-selectable if the system's grammar makes certain elements incompatible with each other through the feedback mechanism.

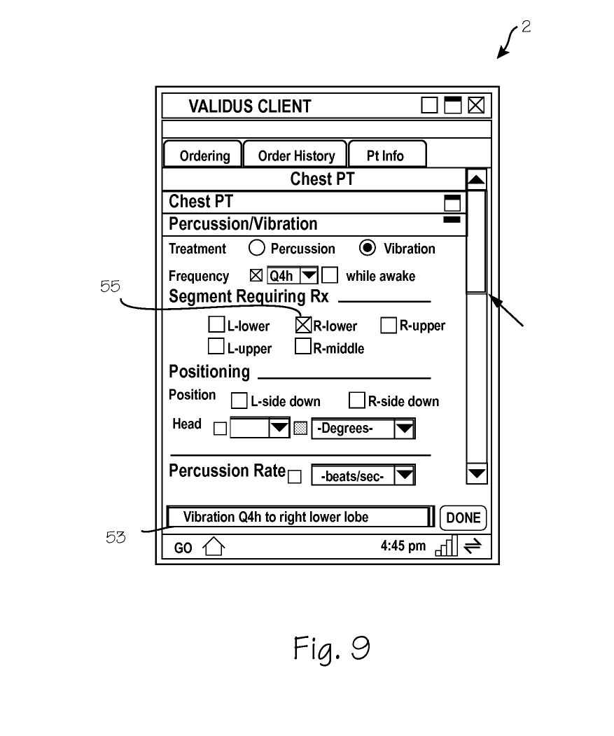

FIG. 9 illustrates the addition of one more item to the order by manipulating a third control element 55. The user interface 2 of order entry form is shown as it appears after the physician has checked the check box “R-Lower” indicated by item number 55, and the system has accepted the input and updated the order status line. The current UI 2 sends the following order contribution to the parser:

[(SVC_Types.Resp_Therapy, ″″), (SVC_Therapies.Vibration, “Vibration”), (TIME_Frequency, “Q4h”), (SVC_Segment_List, “right lower lobe”)]

As shown, the context free-grammar did more than just parse the terminals and concatenate the strings “Vibration” and “Q4h” and “right lower lobe”. The context free-grammar also added the filler word “to” to the order status line 53. This is not the same as using the string “to right lower lobe”. Alternatively, if another box is selected from this group, the system could get generate and display another output such as “Vibration Q4h (Sites=right lower lobe and right upper lobe)” due to a different production rule.

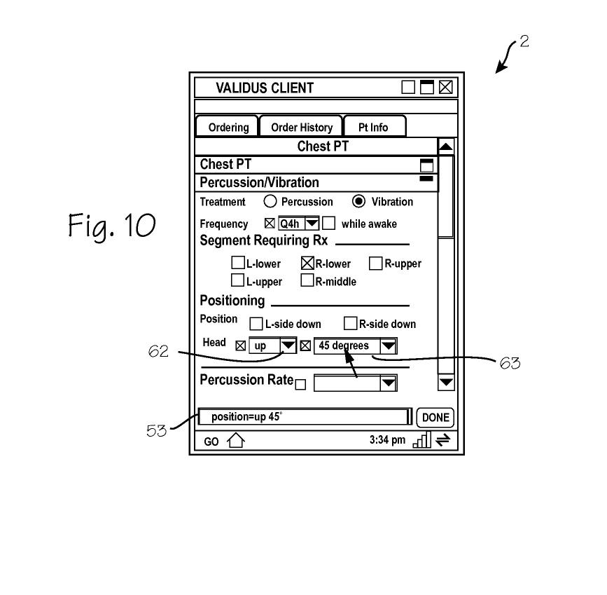

FIG. 10 illustrates the order status line 53 after the checkbox “Head Up” indicated by reference number 62 in the user interface 2 has been selected, and desired head elevation has been entered by the physician. When the radio box “Head Up” is selected, “(position=up)” is written in the order status line by the system. The “Degrees” pull-down 63 is then made active on the order section. The degrees can then be set to 45 degrees using the menu. When the degree amount is set, the order status line natural language string is updated to include “. . . 45 degrees.” Directives in the grammar make the value function insert parentheses and an equal sign.

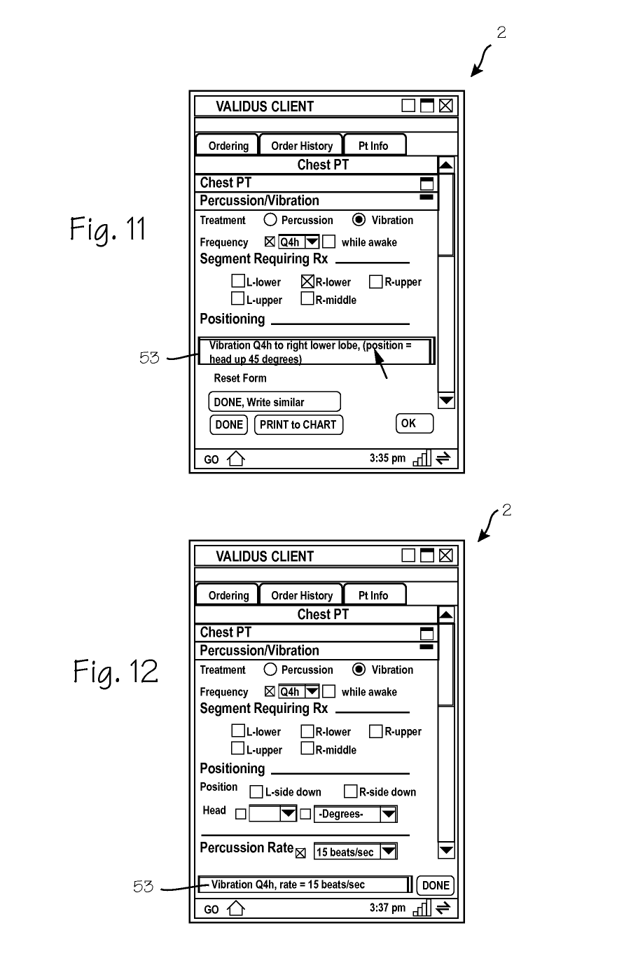

FIG. 11 illustrates the control unit of FIG. 10 with a fully completed physician order displayed in a status line. As shown in FIG. 11, the order status line has been updated by the system to read “Vibration Q4h to right lower lobe (position=up 45 degrees).” Because the order text no longer fits into one page, upon selection of the status line 53 with the input device, the system enlarged the status line to display the entire text of an order as shown in FIG. 11. This standard format string is displayed to the status line of the interface, on the PDA used by the physician, and may also be printed off into a hard paper copy of physician's order using a printer, or inclusion in the patient's medical chart, added to the patient's electronic medical record, and transmitted to the hospital personnel tasked with administering the therapy ordered by the physician.

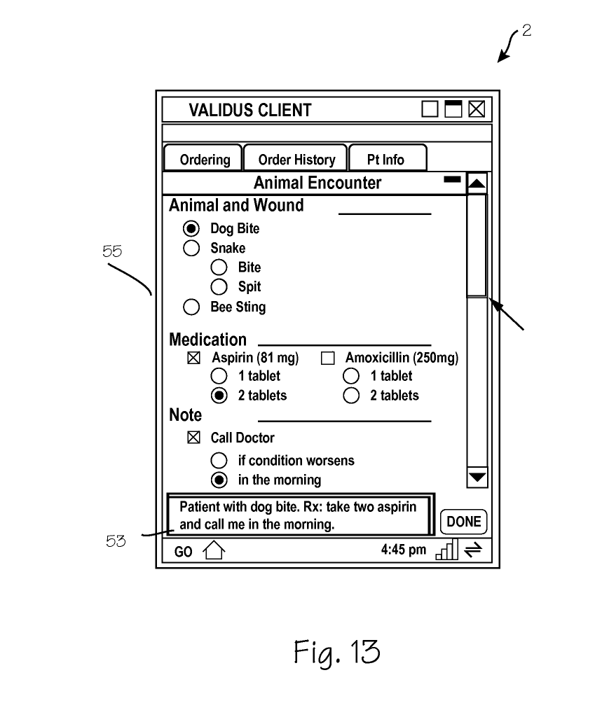

FIG. 12 shows that system also allows a physician to de-select certain control elements in any order in control units, such as those associated with head position and/or percussion and vibration, for which entry histories and context are not limiting. The system in this instance statically evaluates each screen with the snap shot function without regard to the history of user interface events.

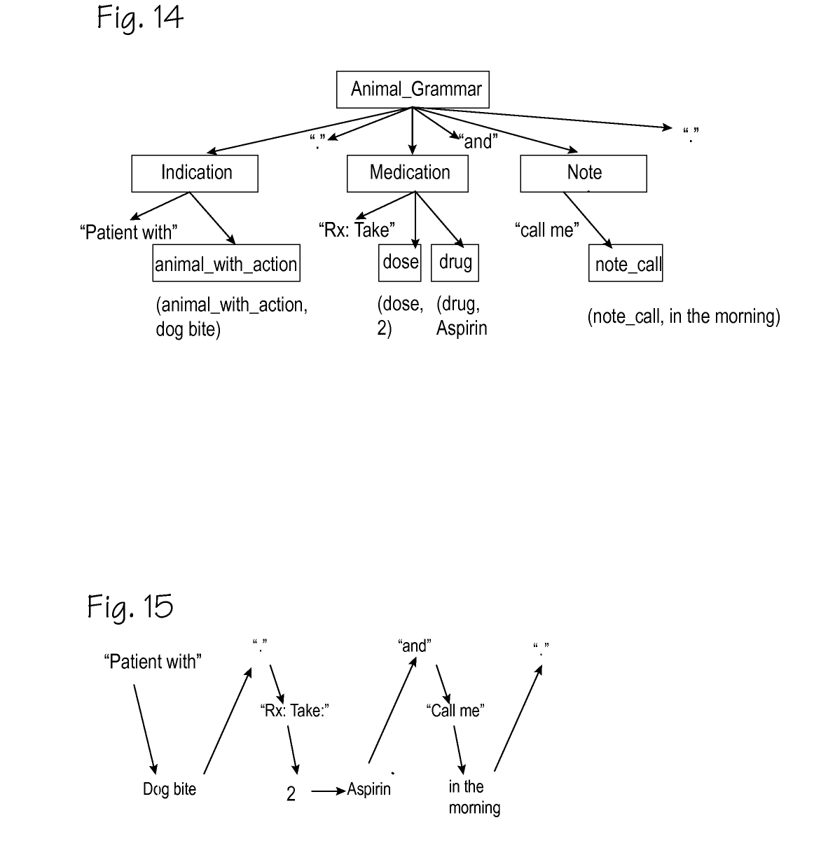

FIGS. 13 through 15 illustrate the operation of the grammar in building a standard format physician order from a series of physician entries in the user interface. In FIG. 14, the content unit 55 represents a simplified order form for a patient that has been bitten by an animal. The physician has entered appropriate entries for a dog bite. In a paper based system, the physician would write the standard form order “Patient with dog bite. Rx: take two aspirin and call me in the morning.” The system has accepted the various control elements and constructed the same standard form order and displayed it in the status line 53. The various control elements of FIG. 13 are governed by a grammar such as the following:

Animal_Grammar ::=Indication {“.”} Medication {“and”} Note }“.”}
   |Indication {“.”} Medication {“.”}
   |Indication {“.”} Note {“.”}
   |Indication {“.”}

Indication ::={“Patient with”} animal_with_action
   |{“Patient with”} animal action

Medication ::={“Rx: Take”} dose drug
   |{“Rx: Take”} dose drug {“and”} dose drug

Note ::={“call me”} note_call

In this example, the grammar maps the entries made by the physician into a standard format order. Each control element is linked to an order contribution, and each order contribution comprises a tuple (a terminal and value). Selection of the radio button for “dog bite” will result in transmission of the tuple (animal, dog) from the physician's PDA to the server. Likewise, selection and transmission of the remaining control elements are interpreted by the system as similar tuples. FIGS. 14 and 15 illustrate the parsing used to generate the standard form order. FIG. 14 illustrates the parse tree generated by the system which operates to place the tuples and extract the terminals and place them into a standard format order shown in the status line 53 of FIG. 13, including necessary fillers such as the words “patient,” ‘Rx: take:” and others. The first element of each order contribution tuple indicates to the grammar which part of the order is represented by the second element of the associated tuple. FIG. 15 illustrates the sequential assignment of tuples, and assignment and insertion of fillers, and concatenation of elements as dictated by the grammar (although the construction need not be sequential: it need only conform to the grammar rule of the information model). The resultant order “Patient with dog bite, Rx take two aspirin and call me in the morning.” This order is in the standard format expected by physicians, hospital personnel, and even patients.

The system and method described above is preferably implemented to cover all potential situations that doctors may be faced with in day-to-day clinical practice. This would include numerous content units and grammar rules such as those exemplified in the figures and accompanying text. The hospitals and clinics using the system, and perhaps professional bodies which promulgate standards of treatment for various groups of physicians, may generate control units which conform to desired standards of treatment for use in the system. These hospitals and clinics central determine a number of control units pertaining to various expected indications, diagnoses, devices, services, therapeutic procedures, diagnostic procedures, and prescriptions. Upon installation in the system, the system promulgates those control units to the various mobile client computers used by the physicians. Corresponding context free grammar rules applicable to the expected indications, diagnoses, devices, services, therapeutic procedures, diagnostic procedures, and prescriptions are also devised centrally and installed in the system, so that all physicians within the system operate with the same control units and context free grammars, which ensures that physician orders are generated in conformity with hospital guidelines.

While the term physician has been used in describing the system, it is meant to refer to doctors, surgeons, nurses, therapists and all other caregivers authorized within an institution, or within a health care system, to generate orders for others governing treatment of the patient. While the system has been described in terms of a server and various thin clients, the various software components may be installed in other areas of the systems if memory and bandwidth is adequate. The system will be implemented with control units pertaining to a number of expected indications, diagnoses, devices, services, therapeutic procedures, diagnostic procedures, and prescriptions, but may be implemented without control windows for some such aspects. Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A method of promulgating physician orders in a hospital comprising:
operating a plurality of mobile client computers to display one or more control units in a graphical user interface on said plurality of mobile client computers, wherein said control units include control elements selectable by a physician to provide input regarding at least one of expected indications, diagnoses, devices, services, therapeutic procedures, diagnostic procedures, and prescriptions;
interpreting the physician input into the control elements as tuples in a predetermined context-free grammar;
constructing a physician order in a standard format by applying the predetermined context-free grammar to the tuples;
promulgating the physician orders to hospital personnel tasked with accomplishing the treatments inputted by the physicians.

2. The method of claim 1 further comprising:
centrally determining a number of control units pertaining to at least one of expected indications, diagnoses, devices, services, therapeutic procedures, diagnostic procedures, and prescriptions, and generating a plurality of context free grammar rules applicable to said at least one of expected indications, diagnoses, devices, services, therapeutic procedures, diagnostic procedures, and prescriptions, and promulgating said control units to said plurality of mobile client computers;
promulgating the grammar rules to a server, and operating said server to receive and interpret information regarding the state of the control units on the plurality of mobile client computers as the physicians provide input to alter the state of the control units, and further operating the server to generate, for each mobile client computer, a valid complete or incomplete physician order corresponding to the status of the control unit currently in use on the particular mobile client computer, and transmit said valid complete or incomplete physician orders to the particular mobile client computers for display in a status line of the particular mobile client computer.

3. The method of claim 1 wherein the step of promulgating comprises printing a paper copy of the physician orders and filing said paper copy in a medical chart pertaining to a patient.

4. The method of claim 1 wherein the step of promulgating comprises transmitting an electronic copy of the physician orders to hospital personnel tasked with accomplishing the treatments inputted by the physicians.

5. A system for generating and promulgating physician orders in a hospital comprising:
a plurality of mobile client computers;
a server operably connected to the a plurality of mobile client computers;
wherein the plurality of mobile computers are programmed to display one or more control units in a graphical user interface, wherein said control units include control elements selectable by a physician to provide input regarding at least one of expected indications, diagnoses, devices, services, therapeutic procedures, diagnostic procedures, and prescriptions;
wherein the server is programmed to apply a context free grammar to tuples derived from the physician input into the control elements to construct a physician order in a standard format and promulgate the physician orders to hospital personnel tasked with accomplishing the treatments inputted by the physicians.

6. The system of claim 5 wherein:
the server is programmed to promulgate a number of control units pertaining to at least one of expected indications, diagnoses, devices, services, therapeutic procedures, diagnostic procedures, and prescriptions to the mobile client computers; and
the server is programmed to receive and interpret information regarding the state of the control units on the plurality of mobile client computers as the physicians provide input to alter the state of the control units, and generate, for each mobile client computer, a valid complete or incomplete physician order corresponding to the status of the control unit currently in use on the particular mobile client computer, and transmit said valid complete or incomplete physician orders to the particular mobile client computers for display in a status line of the particular mobile client computer.

7. The system of claim 5 wherein the server is further programmed to direct printing of a paper copy of the physician orders.

8. The system of claim 5 wherein the server is further programmed transmit an electronic copy of the physician orders to hospital personnel tasked with accomplishing the treatments inputted by the physicians.

9. A system comprising
a server having an information model with a context-free grammar, an information model controller, a parser and a feedback mechanism; and
a wireless device having a graphical user interface with control elements, an interaction model, an interface model controller .
wherein the information model controller is programmed to used input from the control elements in conjunction with the context-free grammar to generate natural language grammar strings.

10. A system comprising:
a processor; and
a memory operably coupled to the processor, the memory containing program code that, when executed by the processor, causes the processor to:
allow a user to manipulate one or more control elements on a graphical user interface, said control elements having or more corresponding input symbols;
generate one or more input sequences from the input symbols;
generate a parse tree using the input sequences;
determine a string value using a function and the parse tree; and
display the string value to the user on the graphical user interface.

11. A computer program article for generating a natural language output using input from a graphical user interface, the computer program article tangibly embodied in a computer-readable medium or propagated signal, the computer program article comprising instructions operable to cause a programmable processor to:
display the graphical user interface to a user and allow the user to manipulate one or more control elements on the graphical user interface, said control element having one or more corresponding input symbols;
generate one or more input sequences from the input symbols;
generate a parse tree using the input sequences;
determine a string value using a function and the parse tree; and
display the string value to the user on the graphical user interface.

12. A method of generating a natural language output comprising:
changing the state of a user interface,
reviewing the status of the user interface control elements and determining which control elements are different from their default states;
collecting individual lexeme type-value pair sequences from each control element;
concatenating the lexeme type-value pair sequences to a natural language string in a deterministic order; and
displaying the natural language string to a user on a graphical user display.
